(19) United States
(12) Patent Application Publication
(10) Pub. No.: US 2026/0195829 A1
(43) Pub. Date: Jul. 9, 2026

(54) SYSTEM AND METHOD FOR CONTROLLING A GREEN HYDROGEN PLANT

(71) Applicant: AES Clean Energy Services, LLC, Salt Lake City, UT (US)

(72) Inventors: Alexander Brissette, Brissette, NC (US); Digna Vora, Houston, TX (US); Pradeep Venkataraman, Spring, TX (US); Jacob Thorson, Westminster, CO (US); Adam Welch, Aurora, CO (US); Mykola Makowsky, Austin, TX (US)

(73) Assignee: AES Clean Energy Services, LLC, Salt Lake City, UT (US)

(21) Appl. No.: 19/427,149

(22) Filed: Dec. 19, 2025

Related U.S. Application Data
(60) Provisional application No. 63/741,878, filed on Jan. 4, 2025.

(51) Int. Cl. G06Q 50/06; C25B 1/02; C25B 15/02

(52) U.S. Cl. CPC G06Q 50/06; C25B 1/02; C25B 15/02

(57) ABSTRACT

A system and method for controlling operation of a hydrogen plant powered at least partly by renewable energy. The system and method may include: automatically accessing an estimated amount of renewable energy for a renewable energy interval; automatically accessing at least one aspect of grid power energy in a power grid interval; automatically accessing a renewable metric having a renewable metric interval for operation of the hydrogen system, wherein the renewable metric interval is different from one or both of the renewable energy interval or the power grid interval; automatically generating, by reconciling the renewable metric interval with the one or both of the renewable energy interval and the power grid interval, one or more commands for control of the hydrogen system; and automatically controlling, using the one or more commands, the hydrogen system.

### REFERENCE TO RELATED APPLICATION

This application claims priority to U.S. Provisional Application Ser. No. 63/741,878 filed Jan. 4, 2025, the entire disclosure of which is hereby incorporated by reference herein.

### FIELD OF THE INVENTION

The present application relates generally to the field of renewable energy, more specifically to controlling a green hydrogen plant.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A green hydrogen plant is a plant that produces hydrogen or hydrogen-derived products using renewable energy (e.g., renewable electricity). For example, the hydrogen is produced by the electrolysis of water whereby electricity is used to split water into oxygen gas (O₂) and hydrogen (H₂) gas by the electrolysis. Hydrogen produced with renewable energy is typically significantly more expensive than hydrogen produced with hydrocarbons (e.g., as of 2024, green hydrogen is three times more expensive than hydrogen produced with hydrocarbons). In this regard, green hydrogen, from a cost perspective, is less viable than hydrogen produced with hydrocarbons.

### SUMMARY

In one or some embodiments, a method for automatically controlling a hydrogen system powered at least partly by renewable energy is disclosed. The method includes: automatically accessing an estimated amount of renewable energy for a renewable energy interval; automatically accessing at least one aspect of grid power energy in a power grid interval; automatically accessing a renewable metric having a renewable metric interval for operation of the hydrogen system, wherein the renewable metric interval is different from one or both of the renewable energy interval or the power grid interval; automatically generating, by reconciling the renewable metric interval with the one or both of the renewable energy interval and the power grid interval, one or more commands for control of the hydrogen system; and automatically controlling, using the one or more commands, the hydrogen system.

In one or some embodiments, a control system for controlling operation of a hydrogen system powered at least partly by renewable energy is disclosed. The control system includes: at least one communication interface; at least one memory; and at least one processor in communication with the at least one communication interface and the at least one memory. The at least one processor configured to: automatically access an estimated amount of renewable energy for a renewable energy interval; automatically access at least one aspect of grid power energy in a power grid interval; automatically access a renewable metric having a renewable metric interval for operation of the hydrogen system, wherein the renewable metric interval is different from one or both of the renewable energy interval or the power grid interval; automatically generate, by reconciling the renewable metric interval with the one or both of the renewable energy interval and the power grid interval, one or more commands for control of the hydrogen system; and automatically transmit, to a controller of the hydrogen system, the one or more commands in order to control the hydrogen system using the one or more commands.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a first block diagram of the hydrogen system, the power sources and the control system.

FIG. 2A is a second block diagram of the hydrogen system, the power sources and the control system, depicting a behind-the-meter (BTM) green hydrogen plant, where the electrolyzer(s) and renewable generation share a single grid connection.

FIG. 2B is a third block diagram of the hydrogen system, the power sources and the control system, depicting a virtual power purchase agreement (VPPA) green hydrogen plant, where the electrolyzer(s) and renewable generation do not share a single grid connection.

FIG. 3A is a first block diagram of the control system, with inputs to and outputs from the control system, and with a first example of an optimizer for the control system.

FIG. 3B is a block diagram of a second example of the optimizer for the control system.

FIG. 4A is a second block diagram of the control system for a BTM green hydrogen plant with no offtake constraint, illustrating inputs to and outputs from the control system, and with the control system including an optimizer, objective terms, and constraints.

FIG. 4B is a second block diagram of the control system for a BTM green hydrogen plant with an offtake constraint, illustrating inputs to and outputs from the control system, and with the control system including an optimizer, objective terms, and constraints.

FIG. 5A is a first block diagram of the control system for a VPPA green hydrogen plant with no offtake constraint, illustrating inputs to and outputs from the control system, and with the control system including an optimizer, objective terms, and constraints.

FIG. 5B is a second block diagram of the control system for a VPPA green hydrogen plant with an offtake constraint, illustrating inputs to and outputs from the control system, and with the control system including an optimizer, objective terms, and constraints.

FIG. 6 is a fourth block diagram of the hydrogen system, the power sources and the control system.

FIG. 7A is a flow chart for controlling the hydrogen system by reconciling different time intervals.

FIG. 7B is a flow chart for controlling the hydrogen system by balancing different financial interests.

FIG. 8 is an example user interface for configuring the control system.

FIG. 9 is a diagram of a computer system that may be utilized to implement the system and methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (e.g., having the potential to, being able to), not in a mandatory sense (e.g., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

When a component, device, element, or the like of the present disclosure is described as having a purpose or performing an operation, function, or the like, the component, device, or element should be considered herein as being “configured to” meet that purpose or to perform that operation or function.

As discussed in more detail below, a hydrogen plant may be considered entirely “green” if it is 100% powered by green or renewable energy. The hydrogen plant may be considered less green if the hydrogen system is powered, at least partly, by non-renewable energy (such as powered by a grid that routes non-green generated power which has at least some carbon intensity based on its generation sources). As discussed in the background, hydrogen produced from an entirely “green” hydrogen plant is typically significantly more expensive to produce than from a non “green” hydrogen plant. This is essentially seen as a failing of “green” hydrogen. However, instead of viewing “green” hydrogen in absolutist terms, one may control the hydrogen system in order to balance the “greenness” of the hydrogen plant with one or more other factors in order to tailor the operation of the hydrogen plant (and in turn the hydrogen or the hydrogen derivatives produced therefrom) to the various factors considered. As discussed in more detail below, “greenness” (including the costs or incentives associated therewith) may be factored along with other costs, including grid energy costs, plant costs, material costs (e.g., water), etc.

Thus, in one or some embodiments, a method to control operation and a control system (alternatively termed a controller) to control operation (such as optimize operation) of a hydrogen system based on one or more factors is disclosed. Various factors may be contemplated in order to control (such as optimize) operation of the hydrogen system, including any one, any combination, or all of: renewability (e.g., a “greenness” metric, such as carbon intensity, which may result in incentives (such as tax incentives) if meeting a greenness threshold, or may result in penalties (such as in losing the tax incentives, incurring tax penalties, or in contractual penalties in not meeting the greenness threshold)); energy costs (e.g., costs in obtaining energy from a grid, and the associated costs therewith); financials (e.g., maximizing profit in operation the hydrogen system; a net cost/revenue target); contractual obligations (e.g., contractual requirements to produce a defined amount of hydrogen or hydrogen-derived products; otherwise, there may be contractual penalties for not producing the contractual requirements, which may be considered in controlling the operation of the hydrogen system); hydrogen system operational constraints (e.g., electrolyzer operational constraints or constraints on other equipment in the hydrogen system, such as electrolyzer supporting equipment, hydrogen storage equipment, or hydrogen derivative generation equipment); base materials (e.g., costs of water or other materials used in the operation of the hydrogen system); or non-hydrogen system operational constraints (e.g., constraints in the grid that may limit power to and/or from the grid). In this way, the operation of the hydrogen system may be specifically tailored to the various factors (and may thus be powered at least partly by renewable energy).

In this regard, the operation of the hydrogen system may be controlled based on any one, any combination, or all of: an estimated amount of renewable energy (alternatively termed renewable power) for powering the hydrogen system (e.g., the amount of power available from PVs/batteries associated with the hydrogen system); an amount of grid power from a grid (and an associated renewable indicator of the grid power from the grid for powering the hydrogen system, with the renewable indicator indicating the greenness of the grid power, such as an amount or percentage of the grid power being generated by one or more renewable energy resources); contractual obligations (e.g., the amount of hydrogen or hydrogen-derived products the hydrogen system is contractually obligated to provide); or operational constraints.

In practice, based on the various factors, a control system may: (i) determine a total amount of power to route to the hydrogen system (e.g., from the grid, from associated renewable energy source(s), such as PVs/batteries, etc.), which may be determined based on the various factors; (ii) send command(s) to power source(s) to route power (e.g., send a command to control routing a first amount of power from the renewable energy source(s) for a respective time interval; send a command to control routing of a second power from the grid for the respective time interval); and (iii) send command(s) to the hydrogen system to control its operation to consume the power routed (e.g., control the ramping up, ramping down, or maintaining operation of the electrolyzers). In this regard, the control of the hydrogen system may be dynamically determined based on the various factors.

In one particular example, renewability, financials, contractual obligations, or operational constraints (e.g., hydrogen system constraints and/or grid constraints) may involve performing any one, any combination, or all of: estimating the renewable energy available (e.g., which may comprise one or both of forecasting or considering real time data); determining one or more aspects (e.g., pricing, carbon intensity) of the grid power available (e.g., pricing of the grid power); determining one or more aspects of hydrogen and/or hydrogen-derived products (e.g., pricing of hydrogen or ammonia); determining requirements for the output of the hydrogen system (e.g., current operational requirements (e.g., current power requirements)); contractual obligations to produce hydrogen and/or hydrogen-derived products (e.g., the contractually-obligated amount(s) of hydrogen and/or ammonia that the hydrogen system is to produce over a defined period of time, and penalties for not meeting the contractually-obligated amount(s)); or determining regulations, the use of which may be affected by operation of the hydrogen system (e.g., tax incentive regulations, the use of which may be affected by the carbon intensity due to operation of the hydrogen system over a defined period);

In this regard, the control of the hydrogen plant may comprise factoring or balancing disparate metrics. However, factoring or balancing such disparate metrics may be exceedingly complex and difficult, particularly in the context of controlling operation of the hydrogen system.

As one example, the various metrics may operate on different timescales or intervals, necessitating reconciling the different timescales or intervals in controlling the hydrogen system. In particular, different timescales may include any one, any combination, or all of: (i) green metric timescale (e.g., carbon intensity); (ii) hydrogen system timescale(s) (e.g., different timescales for controlling equipment within the hydrogen system, such as electrolyzers, or supporting equipment including valves and compressors; different timescales for producing hydrogen and for producing hydrogen-derived products); (iii) renewable energy timescale(s) (e.g., timescale for forecasting available renewable energy; timescale for real-time renewable energy data); (iv) non-renewable energy timescale (e.g., timescale for power grid pricing); or (v) contractual timescale(s) (e.g., contractual timescale for producing hydrogen and/or hydrogen-derived products).

As another example, the metrics may be dependent on various factors, such as any one, any combination, or all of: site dependent (e.g., dependent on the specific site for the hydrogen system due to differences in equipment at the specific site); contract dependent (e.g., dependent on the specific contract terms for offtake of hydrogen and/or hydrogen-derived products); regulation dependent (e.g., dependent on specific regulations for carbon emissions); location-dependent (e.g., dependent on the specific location where the hydrogen system operates for purposes of tax incentives and/or for purposes of grid pricing); or time dependent. As such, the method and system may be configured to tailor to the various dependencies. In one particular example, a user interface may be generated so that a user may provide input in order to tailor to the various dependencies. In this way, the method and system may be readily and easily applied to different contexts, including different hydrogen systems in different locations and in different contractual obligations.

In this regard, a system and method are disclosed that is configured to automatically control operation of a hydrogen system that is powered at least partly by renewable energy. In one specific implementation, the control system is configured, in balancing one or more renewability, financials, contractual obligations, or operational constraints in real time, to generate one or more commands to control the hydrogen system in real time. In performing the real-time balancing, the control system may perform any one, any combination, or all of: (i) automatically determine one or more aspects of the renewable energy; (ii) automatically determine one or more aspects of the power grid; (iii) automatically determine one or more aspects of “greenness” of the hydrogen system (e.g., the carbon intensity of the grid power supplied to the green hydrogen system); (iv) automatically determine operational requirements of the hydrogen system; or (v) automatically determine operational constraints (e.g., of the hydrogen system or of the grid).

As one example, automatically determining one or more aspects of the renewable energy in real time may comprise automatically estimating the amount of renewable energy for a renewable energy interval (e.g., for an upcoming 6 minute interval; for an upcoming 10 minute interval; etc.). Various methodologies are contemplated for automatically estimating the amount of renewable energy including: (i) using a machine-learned model in order to estimate or forecast the amount of renewable energy that is available for use in the upcoming renewable energy interval; (ii) using real-time data (e.g., accessing data indicative of the amount of energy generated by the renewables, such as solar panels, wind power, etc. for a recent renewable energy interval, such as the most recent 6 minute interval); or (iii) using third-party forecasting service. As one example, the machine-learned model may be based on supervised and/or unsupervised learning whereby data from the one or more renewable energy resources (e.g., data for past amounts of generated energy from the specific solar panel site that is providing the renewable energy to the green hydrogen system and/or data for past amounts of generated energy from unrelated solar panel sites) may be used to train the machine-learned model in order to forecast the amount of energy for the upcoming renewable energy interval.

In one or some embodiments, the estimating of the amount of renewable energy for a renewable energy interval may comprise a multi-step process including: (i) generating an initial estimate (e.g., using the machine-learned/artificial-intelligence-based model to generate the initial estimate of the amount of renewable energy for the renewable energy interval; receiving a forecast, from a third party service, of wind or solar in order to generate the initial estimate); and (ii) factoring the real-time data. In one or some embodiments, factoring the real-time data may comprise adjusting the initial estimate of the amount of renewable energy for the renewable energy interval (e.g., revising the initial estimate upward or downward based on the real-time data). Alternatively, or in addition, factoring the real-time data may comprise modifying the load amount for the renewable energy interval (e.g., for the renewable energy interval for the upcoming 6 minutes, the initial estimate may be used to generate an amount of power for use by the load (e.g., the electrolyzer(s)) of the green hydrogen system); real-time generation data, which may be indicative of a real-time amount of the renewable energy generated by the renewable energy system(s) in the past 6 minutes, may be used to revise (such as upward and/or downward) amount of power for use by the load of the green hydrogen system. In either instance, the initial estimate and the real-time data may be used in order to control the amount of power for use by the load. As discussed further herein, the interval for the forecast (e.g., in 6 minute increments; in 10 minute increments) is different from the interval for the renewable metric interval (e.g., hourly and/or yearly). As such, the forecast may include a plurality of sub-intervals of the renewable metric interval, with the control of the load (across the entire renewable metric interval) being such that the renewable metric has at least or at most a predetermined value (e.g., greater than a predetermined amount or predetermined threshold or a predetermined percentage in order to qualify for the designated tax credit and/or a designated contractual obligation); otherwise, in not meeting the predetermined amount or predetermined threshold or predetermined percentage, the system may account for the penalties, such as due to the loss of the designated tax credit and/or due to incurring a tax penalty (e.g., a carbon tax), and/or the contractual loss. In one or some embodiments, the system may automatically determine, based on the various factors, whether to meet the threshold interval by interval, with certain intervals meeting the threshold and other intervals not.

In one or some embodiments, the predetermined threshold is 100% in which to receive the tax credit or meet the contractual obligation, the entire operation of the hydrogen system for the interval is green (e.g., only use of renewable energy). Under such a threshold, the system may determine whether to meet the 100% greenness threshold in certain intervals and not in other intervals, thereby controlling the hydrogen system dynamically based on analysis of the various factors.

Alternatively, the predetermined threshold is less than 100% (e.g., 70%, 80%, or 90%) in which to receive the tax credit or meet the contractual obligation. In such a predetermined threshold, the hydrogen system may receive power from non-renewable sources (such as a power grid powered by fossil fuels). Further, under such a predetermined threshold, the system may factor the greenness of the power from the grid in order to determine whether the hydrogen system may balance receiving power from the grid while still meeting the predetermined threshold in order to receive the tax credit, meet the contractual obligation, or not incur a tax penalty. Likewise, the system may determine whether to meet the predetermined threshold in certain intervals and not in other intervals, thereby controlling the hydrogen system dynamically based on analysis of the various factors.

Further, in the context of the forecast being generated with 6 minute increments resulting in 10 separate forecasts within a respective hour, the separate forecasts may result in a determination for the initial load for the corresponding 6 minute increment based on the respective forecast. After which, real-time data may modify the initial load determination (e.g., revise the value for the initial load determination downward responsive to the real-time data indicating that the renewable energy resource is generating less energy than is forecasted). Further, in one or some embodiments, the real-time data may be analyzed to determine whether to modify each of the initial load determinations. Alternatively, the real-time data may be analyzed to determine whether to modify some, but not all, of the initial load determinations (e.g., the initial load determination for the top of the hour, such as 5:00 to 5:06, relies solely on the forecast for that interval).

As another example, automatically determining one or more aspects of the power grid may comprise: accessing a pollutant metric of the amount of pollutants per kWh of power from the grid; or accessing a price per kWh of power from the grid. As still another example, automatically determining one or more aspects of “greenness” of the hydrogen system may comprise accessing a renewable metric (e.g., a value for a carbon intensity from the grid power being supplied to the hydrogen system) and an associated time interval (e.g., 1 hour). As yet another example, automatically determining the operational requirements of the hydrogen system may comprise automatically determining contractual obligations by the hydrogen system to produce a predetermined amount of hydrogen and/or hydrogen-derived products. As yet another example, automatically determining operational constraints of the hydrogen system may comprise: determining the amount of power needed by various components to operate within the hydrogen system (e.g., the amount of kWh for the electrolyzer(s) of the hydrogen plant to produce 1 kg of Hydrogen); and/or determining the constraints of operation of the various components (e.g., the electrolyzers must operate within a designated range of 15-70 MW; such as the electrolyzers have predetermined timescale constraints of ramping up and/or ramping down).

Various renewable metrics are contemplated. As one example, carbon intensity (CI) (interchangeably known as emission intensity) may comprise the carbon rate or the emission rate of a given pollutant relative to the intensity of a specific activity, such as the amount of one or both of: production of hydrogen (H₂); or production of hydrogen-derived products (e.g., one or both of ammonia or methanol). In this regard, the CI may comprise a ratio (e.g., an actual ratio or an estimated ratio) of the amount of pollutants (e.g., kilograms (kg) of carbon dioxide (CO₂)) to the amount of product generated (e.g., kg of any one, any combination, or all of: H2; ammonia; or methanol).

In one or some embodiments, power from a power grid may have an associated pollutant metric, such as kg of CO₂ per MWh of power used from the power grid. Likewise, the hydrogen system may be configured to produce the hydrogen and/or the hydrogen-derived products. As discussed in more detail below, the system and method are configured to determine how much energy (e.g., how much power) is consumed by the part or all of the hydrogen system to produce a predefined amount of hydrogen or a predefined amount of hydrogen-derived products (e.g., producing 1 kg of hydrogen requires X amount of MW; producing 1 kg of ammonia requires Y amount of MW). Thus, as a practical matter, the lower the value of X is, the more efficient the electrolyzers are that produce the hydrogen. Conversely, the higher the value of X is, the less efficient the electrolyzers are that produce the hydrogen.

Merely by way of example, the control system may estimate the amount of power received from the renewable energy system(s) (e.g., 90 MW in the upcoming time period of 5:00 to 5:10). In the present example, the power grid may have an associated pollutant metric of 100 kg of CO₂ per 1 MWh. Further, in optimizing the operation of the hydrogen system (discussed further below), the control system may automatically determine that the hydrogen system will receive 10 MW of power from the power grid in a prescribed interval (e.g., in the upcoming time period of 5:00 to 5:10), thereby translating to 1,000 kg₂ of CO2 for the 10 MW of power used by the hydrogen system from the power grid. Thus, the control system, balancing the various factors (e.g., based on contractual obligations and/or based on the estimated CI for the CI time interval (such as for the upcoming hour from 5:00 to 6:00)), may determine that the power grid is to supply 10 MWh in the upcoming time period of 5:00 to 5:10. The control system may thus generate the one or more commands in order to: route the power from the various sources (e.g., in the upcoming time period of 5:00 to 5:10, route the 90 MW from the renewable energy system(s) to the load of the green hydrogen system; in the upcoming time period of 5:00 to 5:10, route the 10 MW from the power grid to the load of the hydrogen system); and control the operation of hydrogen system in real time (e.g., control the electrolyzer(s) to use the 100 MW of power in the upcoming time period of 5:00 to 5:10).

As discussed above, balancing the various factors (e.g., renewability, financials, contract obligations, or operational constraints) may be difficult. This may be especially difficult when considering the obstacles of controlling the hydrogen system in real time, such as reconciling the different time intervals involved in the various factors. As one example, one or both of the renewable resources (e.g., the solar systems; wind farms; etc.) or the power grid may have a different associated time interval from the time interval for the renewable metric. Specifically, the forecasting for the estimated amount of renewable energy may be on a different time scale (such as every 6 minutes, every 10 minutes, etc.) from the renewable metric interval for the CI (e.g., hourly and/or yearly). Thus, in one particular embodiment, the system and the method may perform the automatic control, essentially reconciling the different intervals, by: automatically accessing an estimated amount of renewable energy for a renewable energy interval; automatically accessing at least one aspect of grid power energy a power grid interval; automatically accessing a renewable metric having a renewable metric interval for operation of the green hydrogen system, wherein the renewable metric interval is different from one or both of the renewable energy interval or the power grid interval; automatically generating, by reconciling the renewable metric interval with the one or both of the renewable energy interval and the power grid interval, one or more commands for control of operation of the hydrogen system; and automatically controlling, using the one or more commands, the operation of the hydrogen system. In this particular example, there may be multiple sub-intervals of the renewable energy interval (e.g., six sub-intervals of 10 minutes each) for one time interval for the CI (e.g., where the CI interval is 1 hour). To reconcile this, the control system is configured to (for each respective sub-interval of the plurality of sub-intervals): automatically generate the estimated amount of renewable energy; and automatically generate a load amount for powering at least a part of the green hydrogen system, wherein the load amount is automatically generated based on the estimated amount of renewable energy. In this way, the load amount for each of the plurality of sub-intervals (which add up to 1 hour for the CI interval of 1 hour) is automatically selected so that a sum of the non-renewable energy or the emission intensity, used for the plurality of sub-intervals to produce the one or both of the hydrogen or the hydrogen-derived products, resulting in a value for the renewable metric to be less than a predetermined amount (e.g., the total value for the CI for that respective hour is less than the predetermined amount for a tax credit).

Further, in one or some embodiments, the renewable metric (e.g., the CI) may have associated therewith multiple renewable metric intervals, such as a first renewable metric interval and a second renewable metric interval (that is different from the first renewable metric interval). Further, in one or some embodiments, the predetermined value for the CI for the respective intervals may be the same (e.g., to qualify for the tax credit, the value of the CI for the hydrogen system is less than the same predetermined value for the hourly CI and for the yearly CI). Alternatively, the predetermined value for the CI for the respective intervals may be different. Regardless, in this implementation, the control system may account or consider both intervals when generating the commands for the loads in the hydrogen system. It is noted that the CI with the longer interval may have a greater latitude in selecting the values for the loads due to its longer interval, as opposed to the CI with the shorter interval potentially having lesser latitude in selecting the values for the loads.

Separate from, or in addition to the above, the control system may factor (such as in real time) various costs, such as any one, any combination, or all of: costs for receiving power from the power grid; costs for failing to meet contractual obligations for producing hydrogen and/or hydrogen-derived products; or costs for meeting (or failing to meet) tax incentives due to greenness (e.g., whether the CI for a respective renewable metric interval meets the federally mandated guidelines for receiving the tax credit). Thus, in one or some embodiments, the control system may select the load amount (e.g., reducing the load amount so that less of the hydrogen and/or the hydrogen-derived products is produced) for powering the hydrogen system so that the CI is within the federally mandated guidelines, thereby optimizing costs for the one or both of the hydrogen or the hydrogen-derived products produced by the hydrogen system. In this way, various factors, including any one, any combination, or all of renewability, financials, contractual obligations, or operational constraints, may be analyzed (such as in real time) in order to control operation of the hydrogen system (and, in turn, tailor the greenness of operation of the hydrogen system to comply with the various factors).

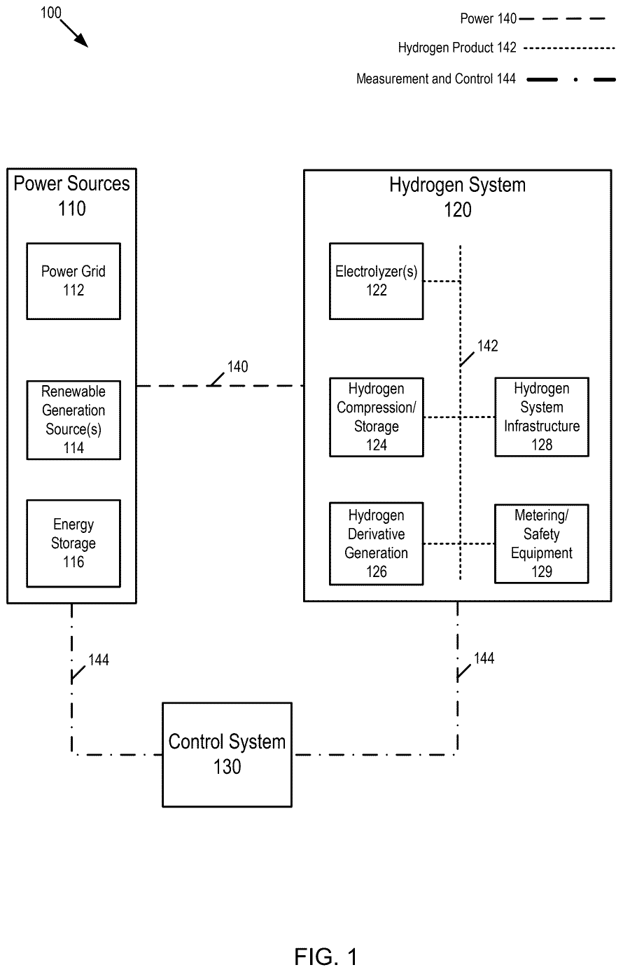

FIG. 1 is a first block diagram 100 of the hydrogen system 120, the power sources 110 and the control system 130. The power sources 110 may include any one, any combination, or all of: a power grid 112; renewable generation source(s) 114; or energy storage 116. The power grid 112 (interchangeably termed a grid or macrogrid) may comprise an interconnected network for electricity delivery from producers to consumers. Power grids typically include: power stations (interchangeably a power plant, generating station, or generating plant that may operate using coal, natural gas, nuclear power, or hydroelectric power) that generate power; electrical substations (interchangeably termed substations) that step the voltage up or down; and electrical power distribution where the voltage is stepped down again to the required service voltage(s) for the end customers. Further, the power grid 112 may have an associated pollutant metric, as discussed above.

The renewable energy resource(s) 114 may comprise one or more systems that generate renewable energy, such as any one, any combination, or all of solar renewable energy system(s) (e.g., operate using photovoltaic power), wind farms (e.g., using wind turbines), geothermal, biomass, etc. Energy storage 116 may comprise a battery-based storage system, such as a battery energy storage system (BESS). The BESS typically uses a plurality of batteries to store electrical energy. The BESS may be used in various ways. For example, the BESS may be used to store excess energy generated from renewable sources like solar energy or wind energy. The BESS may also be used to stabilize the electrical grid by providing backup power, balancing supply and demand, and mitigating fluctuations in renewable energy production.

The hydrogen system 120 may include any one, any combination, or all of: electrolyzer(s) 122; hydrogen compression/storage 124; hydrogen derivative generation 126; hydrogen system infrastructure 128; or metering/safety equipment 129. In one or some embodiments, hydrogen system 120 may use the electrolyzer(s) 122 to generate hydrogen via electrolysis, where an electric current is passed through water to separate the hydrogen and oxygen molecules. Further, hydrogen compression/storage 124 may comprise one or more hydrogen compressors and one or more tanks. In one or some embodiment, the hydrogen generated by the hydrogen system 120 may be used by hydrogen derivative generation 126 to generate one or more hydrogen-derived products, such as one or both of ammonia or methanol. Hydrogen system infrastructure 128 may comprise various components, such as cabling and switchgear for the electrical components, pumps, compressors, piping, etc. for the hydrogen components, or the like that is used in support of the electrolyzer(s) 122, the hydrogen compression/storage 124 and/or hydrogen derivative generation 126. Thus, the hydrogen generated by the hydrogen system 120 may be sold directly to an offtaker (e.g., via a contract), buffered in a hydrogen storage system, and/or converted to a derivative (e.g. ammonia) either directly or from stored hydrogen.

FIG. 1 further illustrates control system 130, which may be in communication with one or both of power sources 110 or hydrogen system 120. As shown, various paths are illustrated in FIG. 1 for power (show as 140), for hydrogen product (shown as 142 and which may include one or both of hydrogen or hydrogen-derived products), and for measurement and control (shown as 144). As shown in FIG. 1, control system 130 is separate from both power sources 110 and hydrogen system 120. Alternatively, control system 130 may be included in one or both of power sources 110 or hydrogen system 120. For example, control system 130 may be included within hydrogen system 120. Thus, the hydrogen system 120 (alternatively termed a green hydrogen system or a green hydrogen plant) may comprise: hydrogen generation (e.g., one or more electrolyzers 122); renewable energy generation (PV, wind, geothermal, biomass, etc.); and control system 130. As discussed further below, the hydrogen system 120 may include a connection to the power grid 112, electrical energy storage in the form of energy storage 116 (e.g., batteries, thermal storage, etc.), and hydrogen storage in the form of hydrogen compression/storage 124.

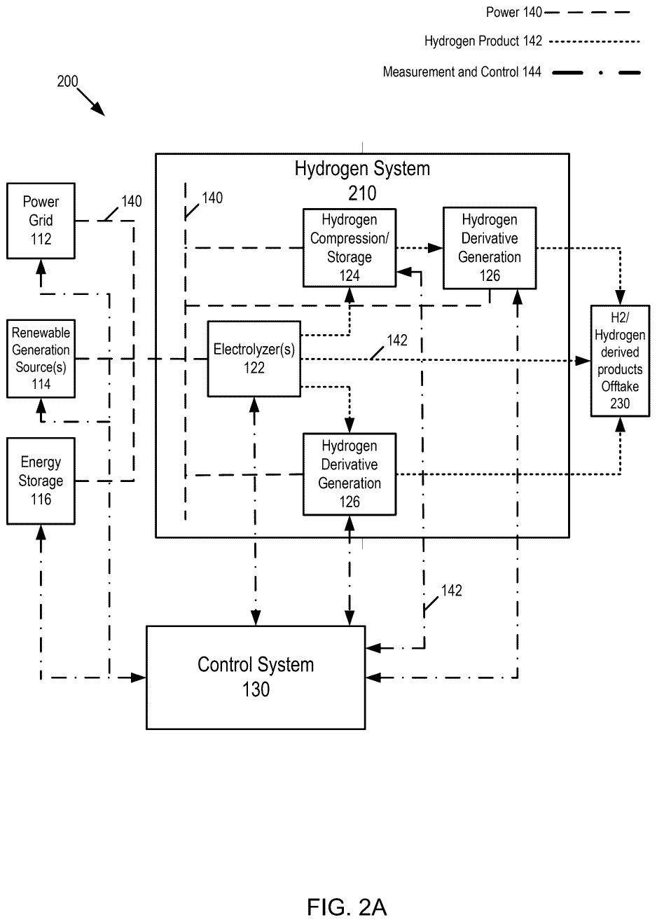

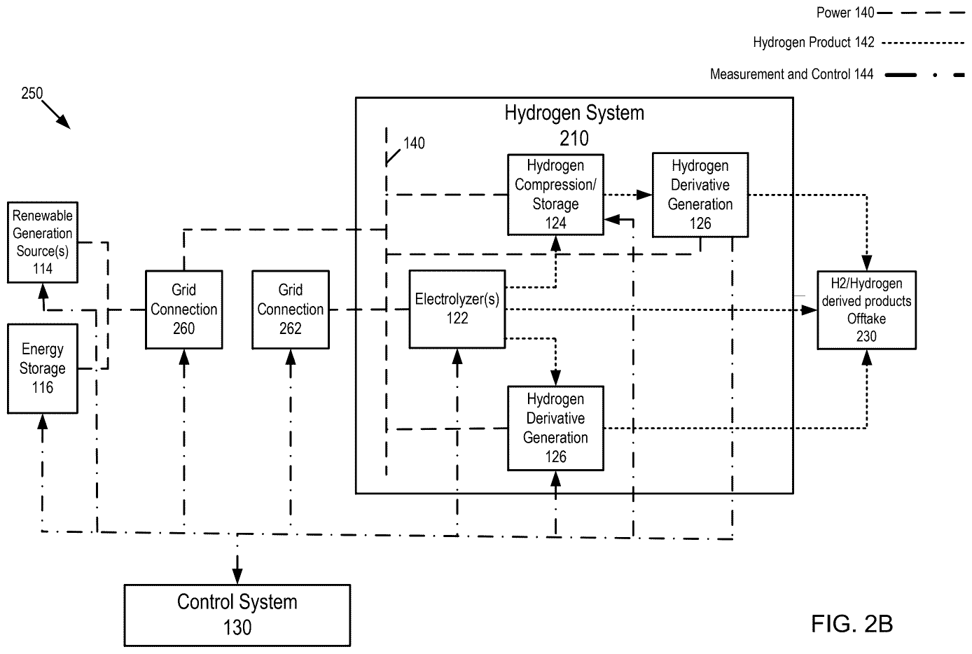

FIG. 2A is a second block diagram 200 of the hydrogen system 210, the power sources and the control system 130, depicting a behind-the-meter (BTM) hydrogen plant, where the electrolyzer(s) 122, renewable generation source(s) 114 and energy storage 116 may share a single grid connection. Alternatively, or in addition, the hydrogen system 210 may be islanded with no electrical connection to the power grid 112. As shown, hydrogen and/or hydrogen-derived products may be routed to H₂/hydrogen-derived products offtake 230, which may comply with various offtake contracts.

FIG. 2B is a third block diagram 250 of the hydrogen system 210, the power sources and the control system 130, depicting a virtual power purchase agreement (VPPA) green hydrogen plant, where the electrolyzer(s) 122 and renewable generation source(s) 114 do not share a single grid connection, instead having grid connection 260 and grid connection 262. In this regard, FIG. 2B illustrates an alternative green hydrogen system where the electrical side and the hydrogen side of the arrangement do not share the same grid connection, which may have financial advantages in certain situations.

Thus, the control system 130 (interchangeably referred to as a controller) may be configured to control any one, any combination, or all of: the electrolyzers 122; renewable generation source(s) 114; and other equipment in such a way that achieves a predetermined financial outcome (such as an optimized financial outcome and/or a net cost/revenue target). In one or some embodiments, this may be manifested in controlling the equipment so that the electrolyzers'electrical load matches the renewable output over some repeating time interval determined by the project requirements. In particular, the control system 130 may seek to match on a second-by-second, hourly, daily, or annual basis, for example, with the outputs of the control system 130 being schedules of commands to the various equipment over the interval for matching. As discussed above, the control system 130 may be applied to a variety of contexts, such as illustrated in FIGS. 1 and 2A-B. The control system 130 may be configured to perform the matching, which may typically deliver the best financial performance for the whole plant. Alternatively, the control system 130 may be configured not to ensure a match in some intervals, or need not provide matching at all.

In one or some embodiments, energy matching may be difficult for photovoltaic (PV) and wind generation, which may be considerably variable; however, the control may be improved with the renewable generation forecast used as an input to the control system 130, as discussed herein. For renewable sources that are not variable, such as dispatchable generation, the control may be more straightforward. Dispatchable generation may come from one or more sources. As one example, the power grid 111 may provide power to the hydrogen system 120. Alternatively, or in addition, the hydrogen system 120 may have associated therewith dispatchable generation (e.g., a hydroelectric dam or a geothermal generator, which may be co-located with the hydrogen system 120 or associated with the hydrogen system 120 through a VPPA). Specifically, the control system 130 may control the dispatch to match the rated electrolyzer load, and may be varied responsive to the control system 130 determining that the load needs to change.

In one or some embodiments, the system may include energy storage (e.g., batteries), such as energy storage 116. In such a system, the matching requirement may be less strict. For example, responsive to determining that there is a mismatch between the electrolyzer load and the amount of renewable generation energy, the difference may be stored in (for excess renewable generation energy) or drawn from the energy storage device (for a deficit in renewable generation energy). In such a case, the control system 130 may be configured to manage the state of stored energy in the storage device (e.g., the state of charge (SOC) in the context of batteries) to prevent the storage device from becoming fully depleted or overcharged. For variable generation, managing the storage SOC may be improved with the forecast of the renewable resource. For example, responsive to determining that the renewable resource is forecast to be abundant in the near future (e.g., within the next hour, the next day, the next week, etc.), the control system 130 may dispatch more energy from the storage resource beforehand, anticipating the upcoming opportunity to recharge.

In one or some embodiments, the hydrogen plant may also match the demands of the hydrogen offtaker. In one or some embodiments, this matching may require similar time matching as the renewable electrical generation and load in the hydrogen plant, where the hydrogen plant may be required to produce a certain amount of hydrogen over a repeating time interval (e.g., according to contract constraints). Responsive to determining that the hydrogen production rates may vary due to varying electrical input, hydrogen storage may be used as a buffer (see hydrogen compression/storage 124). As with electrical energy storage, the control system 130 may be configured to manage the hydrogen storage to ensure the hydrogen storage is not overfilled while meeting the offtake requirements. On the other hand, if the offtake is flexible (e.g., if the hydrogen is fed into a pipeline), there may be no need for hydrogen storage.

Further, hydrogen may be sold as a hydrogen-derivative product, like ammonia or methanol, rather than elemental hydrogen (see hydrogen derivative generation 126). In this case, the hydrogen system for converting hydrogen to the derivative product may be included in the hydrogen plant, such as illustrated in FIGS. 1 and 2A-B, in which case the process may be controlled by the control system 130. As shown in FIGS. 1 and 2A-B, the hydrogen may be supplied directly from the electrolyzer(s), or may be buffered by hydrogen storage.

In one or some embodiments, the system may be electrically connected to the power grid 112 (e.g., the local utility or transmission system). Similar to an electrical energy storage device, the power grid connection may act as a buffer between variable renewable generation and the electrolyzer load. The control system 130 may manage any constraints associated with the power grid connection. In some cases, exporting, and in other cases, importing energy to/from the power grid may be prohibited; in this regard, the control system 130 may adjust the generation and load accordingly. A power grid connection may also introduce economic considerations that may be managed by the control system 130. For example, in certain situations, the prices to purchase or sell energy may vary over time, so the hydrogen plant's economic performance may be improved through intelligent arbitrage (which may be programmed into the control system 130). Again, this performance may be improved responsive to the control system 130 having access to forecasts of renewable generation and energy prices.

Finally, the power grid connection may also have an impact on the “greenness” of the hydrogen based on the carbon intensity of the energy imported from the power grid and the relative proportions of power grid energy and local renewable energy used to produce the hydrogen. Responsive to the hydrogen plant having a target total carbon intensity, the control system 130 may use that as an input for setting appropriate levels of any one, any combination, or all of electrolyzer load, renewable output, energy storage, or hydrogen storage.

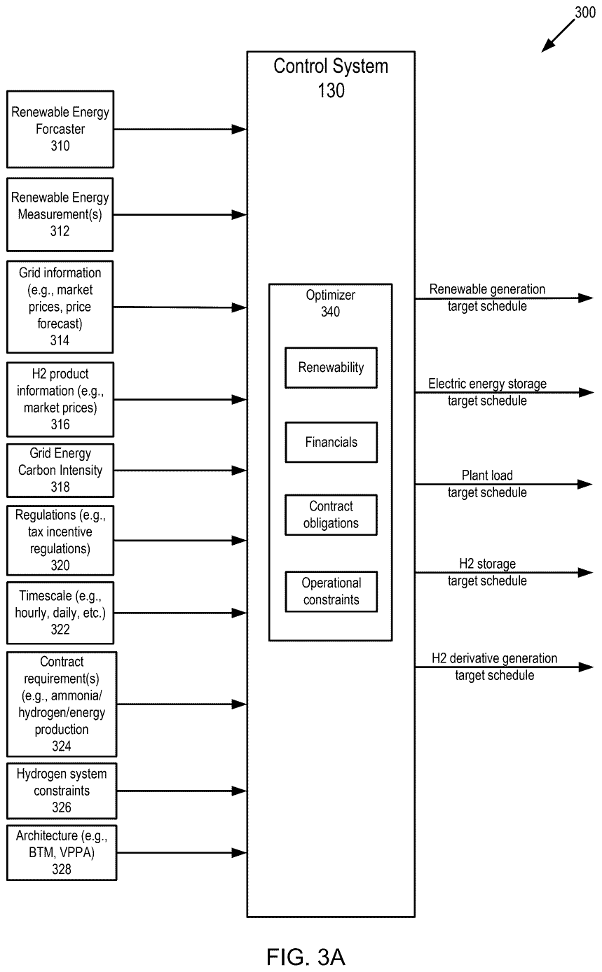

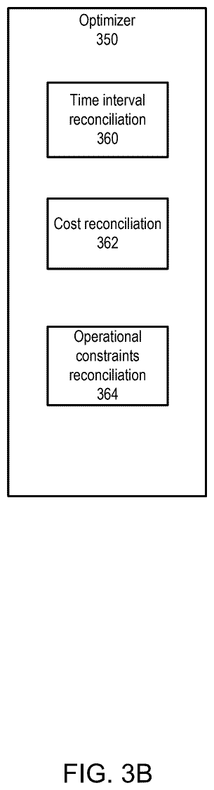

FIG. 3A is a first block diagram 300 of the control system 130, with inputs to and outputs from the control system 130, and with a first example of an optimizer 340 for the control system 130. As shown, FIG. 3A may include any one, any combination, or all of the following inputs: renewable energy forecaster 310; renewable energy measurement(s) 312; grid information 314; hydrogen (H₂) product information 316; grid energy carbon intensity (CI) 318; regulations 320; timescale 322; contract requirement(s) 324; hydrogen system constraints 326; or architecture 328.

In one or some embodiments, renewable energy forecaster 310 may comprise a model configured to estimate the amount of renewable energy that is generated by the one or more renewable energy resources. As one example, the model may comprise a machine-learned model or an AI model that is configured to generate a forecast for an amount of renewable energy that is produced and/or is available for routing to the hydrogen system in an upcoming interval (e.g., an immediate upcoming interval, such as the next 6 minutes or the next 10 minutes; a non-immediate upcoming interval, such as a 6 minute interval starting 6 minutes from the current time, etc.).

Renewable energy measurement(s) 312 may comprise one or more real-time measurements of the power generated by the renewable energy resources. As discussed herein, the real-time measurements may be used to adjust one or both of the forecast or the load for the hydrogen system. Grid information 314 may comprise one or more aspects of the grid, such as market prices, pricing forecast, pollutant metric of the power grid, etc. Hydrogen (H₂) product information 316 may comprise one or more aspects of hydrogen, such as market prices for hydrogen. Grid energy carbon intensity (CI) 318 may comprise one or more aspects of the CI. Regulations 320 may comprise tax incentive regulations for operation of the hydrogen system, such as tax incentives for complying with or meeting CI regulations. In one or some embodiments, the tax incentives may be location-determinative, such as in which country the hydrogen system is located. Timescale 322 may comprise whether various metrics, such as the CI, the renewable forecast, the load operation, the grid operation, may have associated respective timescales. Contract requirement(s) 324 may comprise contract terms that indicate requirements for production of the one or both of the hydrogen or the hydrogen-derived products with financial penalties for failing to meet the requirements for the production of the one or both of the hydrogen or the hydrogen-derived products. Hydrogen system constraints 326 may comprise various operational constraints of the hydrogen system (e.g., electrolyzer operational constraints or constraints on other equipment in the hydrogen system, such as electrolyzer supporting equipment, hydrogen storage equipment (e.g., compressors may have a different turndown rate versus other devices within the hydrogen system), or hydrogen derivative generation equipment; predetermined timescale constraints of ramping up and/or ramping down). Architecture 328 may comprise the type of architecture, such as behind the meter (BTM) architecture or a non-BTM architecture (e.g., with a virtual power purchase agreement (VPPA)).

As shown in FIG. 3A, the optimizer 340 may be configured to balance or factor one or more aspects, such as any one, any combination, or all of: renewability (e.g., greenness); financials (e.g., maximizing profit); contract obligations (e.g., meeting the obligations as designated by a offtake contract for the hydrogen system and/or accounting for the penalties of not meeting the obligations as designated by a offtake contract); or operational constraints (e.g., accounting for constraints of any one, any combination, or all of the hydrogen system, the renewable energy resource(s), or the power grid).

Further, as shown in FIG. 3A, the control system 130 may be configured to generate one or more outputs, including one or more target schedules for controlling operations of one or more resources. In one embodiment, the target schedules may include as any one, any combination, or all of: renewable generation target schedule (e.g., a target schedule for control of the renewable energy resource(s); in one or some embodiments, the renewable generation target schedule equals the forecast of the renewable generation resource(s); alternatively, the renewable generation target schedule may be different from the forecast, such as in the instance where renewable energy may be purchased from multiple renewable generation resources); electric energy storage target schedule (e.g., a target schedule for control of the electric energy storage); plant load target schedule (e.g., a target schedule for control of the plant load, such as control of the various components within the hydrogen system such as the electrolyzer(s), etc.); hydrogen (H₂) storage target schedule (e.g., a target schedule for control of the H₂ storage in the hydrogen system, which may be performed by hydrogen compression/storage 124); or hydrogen (H₂) derivative generation target schedule (e.g., a target schedule for control of the H₂ derivative generation in the hydrogen system, which may be performed by hydrogen derivative generation 126). In one or some embodiments, the one or more outputs (whether manifested in the target schedules or in another form) may include one or more commands that may be issued by control system 130 in order to control one or more parts of the hydrogen system (e.g., the electrolyzer(s) 122, hydrogen compression/storage 124, hydrogen derivative generation 126, hydrogen system infrastructure 128, etc.) and/or the power sources 110 (e.g., any one, any combination, or all of routing power to and/or from the power grid 112, renewable generation source(s) 114, or energy storage 116). In this regard, the control system 130 may be configured to generate the one or more commands in order to control the various resources according to the target schedules.

FIG. 3B is a block diagram of a second example of the optimizer 350 for the control system 130. As discussed above, various reconciliations may be performed, such as any one, any combination, or all of: time interval reconciliation 360; cost reconciliation 362; or operational constraints reconciliation 364. As one example, time interval reconciliation 360 may reconcile the different time intervals as discussed herein. As another example, cost reconciliation 362 may be configured to optimize or balance the various costs, such as power costs (e.g., accessing power from the power grid) or operational costs (e.g., costs in terms of operating the hydrogen system). As still another example, operational constraints reconciliation 364 may reconcile different operational constraints within the overall system, such as operational constraints within any one, any combination, or all of: the hydrogen system; the renewable energy resource(s); or the power grid.

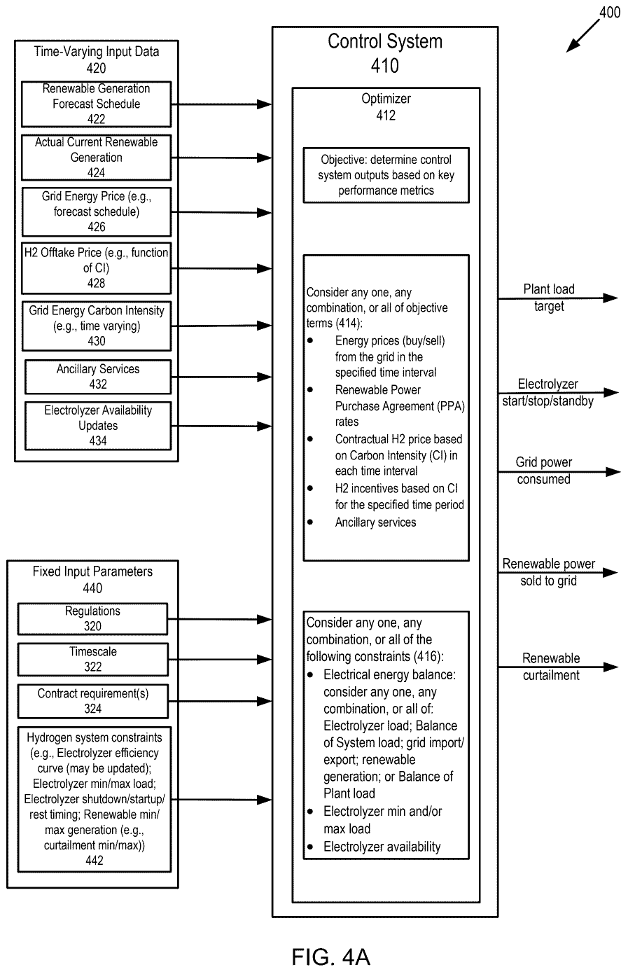

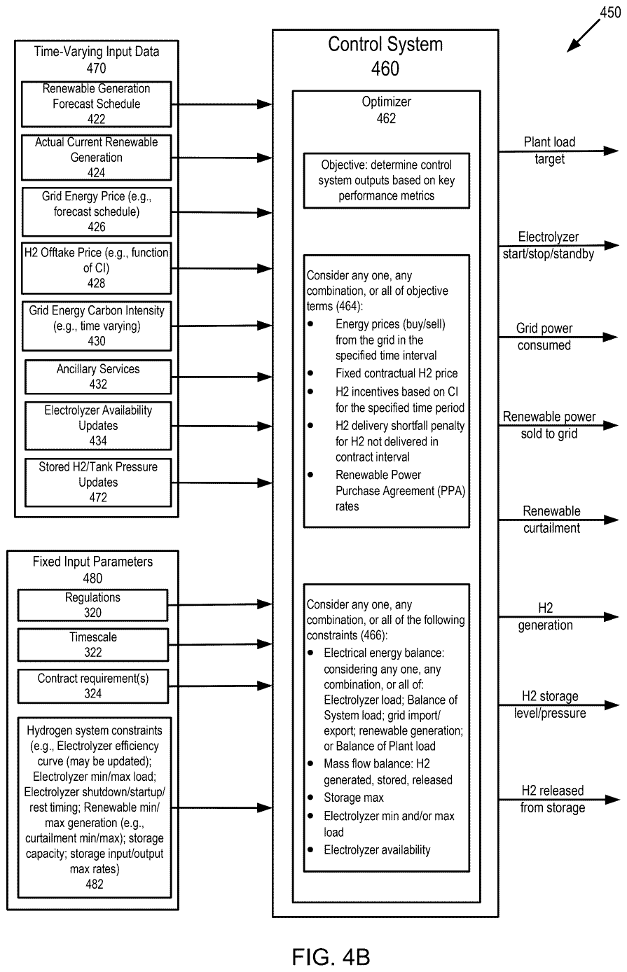

FIG. 4A is a second block diagram 400 of the control system 410 for a BTM green hydrogen plant with no offtake constraint, illustrating inputs to and outputs from the control system, and with the control system including an optimizer, objective terms, and constraints. Specifically, the inputs may comprise one or both of time-varying input data 420 or fixed input parameters 440. The time-varying input data 420 may include any one, any combination, or all of: renewable generation forecast schedule 422; actual current renewable generation 424; grid energy price (e.g., forecast schedule) 426; H₂ offtake price (e.g., as a function of the CI) 428; grid energy carbon intensity 430 (which may be time varying); ancillary services 432; or electrolyzer availability updates 434. The fixed input parameters 440 may include any one, any combination, or all of: regulations 320; timescale; 322; contract requirement(s) 324; or hydrogen system constraints (e.g., electrolyzer efficiency curve (may be updated); electrolyzer min/max load; electrolyzer shutdown/startup/rest timing; Renewable min/max generation (e.g., curtailment min/max)) 442. In one or some embodiments, the grid energy price 426 may be received via one or more protocols, such as Open Platform Communications (OPC), OPC Unified Architecture (UA), Modbus or the like.

FIG. 4A further illustrates that control system 410 may include optimizer 412 that includes any one, any combination, or all of: objective(s); objective term(s) 414; or constraint(s) 416. The objective(s) may determine control system outputs based on key performance metrics. The objective term(s) 414 may include any one, any combination, or all of: energy prices (buy/sell) from the grid in the specified time interval; renewable Power Purchase Agreement (PPA) rates; contractual H₂ price based on CI in each time interval; H₂ incentives based on CI for the specified time period; or ancillary services. The constraint(s) 416 may include any one, any combination, or all of: electrical energy balance (e.g., any one, any combination, or all of: electrolyzer load; Balance of System (BoS) load; grid import/export; renewable generation; or Balance of Plant (BoP) load); electrolyzer min and/or max load; or electrolyzer availability. The PPA may comprise a contract for a buyer to buy energy from a generator at a certain price. A production tax credit (PTC) may comprise, in the context of a hydrogen system, a special tax credit for hydrogen producers who meet certain regulations (e.g., CI values for designated time intervals). As discussed above, the hydrogen system may include electrolyzer(s) and supporting or related equipment. Each respective part may be controlled any may have associated power needs. As one example, a balance of system (BOS) may comprise equipment related to the electrolyzer(s), such as the supporting equipment for a single electrolyzer unit, which may consume electrical energy (e.g. a pump). As another example, the balance of plant (BOP) may comprise the supporting equipment for the entire multi-electrolyzer plant, which is separate from the BOS equipment, and which may also consume electrical energy (e.g., operation of a storage tank compressor).

As shown in FIG. 4A, the control system 410 is configured to generate one or more outputs, such as any one, any combination, or all of: plant load target; electrolyzer start/stop/standby; grid power consumed; renewable power sold to grid; or renewable curtailment.

FIG. 4B is a second block diagram 450 of the control system 460 for a BTM green hydrogen plant with an offtake constraint, illustrating inputs to and outputs from the control system, and with the control system including an optimizer, objective terms, and constraints. As shown, various inputs to the control system 460 such as one or both of input data 470 with the exception fixed input parameters 480. Input data 470 with the exception fixed input parameters 480. are similar to time-varying input data 420 with the exception of stored H₂/tank pressure updates 472, and hydrogen system constraints (e.g., electrolyzer efficiency curve (may be updated); electrolyzer min/max load; electrolyzer shutdown/startup/rest timing; renewable min/max generation (e.g., curtailment min/max); storage capacity; storage input/output max rates) 482.

Control system 460 includes optimizer 462, which may include any one, any combination, or all of: objective(s); objective term(s) 464; or constraint(s) 466. The objective term(s) 464 may include any one, any combination, or all of: energy prices (buy/sell) from the grid in the specified time interval; fixed contractual H₂ price; H₂ incentives based on CI for the specified time period; H₂ delivery shortfall penalty for H₂ not delivered in contract interval; or renewable power purchase agreement (PPA) rates. The constraint(s) 466 may include any one, any combination, or all of: electrical energy balance (e.g., considering any one, any combination, or all of: electrolyzer load; BoS load; grid import/export; renewable generation; or BoP load); mass flow balance (e.g., H₂ generated, stored, released); storage max; electrolyzer min and/or max load; or electrolyzer availability.

As shown in FIG. 4B, the control system 460 is configured to generate one or more outputs, such as any one, any combination, or all of: plant load target; electrolyzer start/stop/standby; grid power consumed; renewable power sold to grid; renewable curtailment; H₂ generation (e.g., according to the offtake contract); H₂ storage level/pressure (e.g., according to the offtake contract); or H₂ released from storage (e.g., according to the offtake contract).

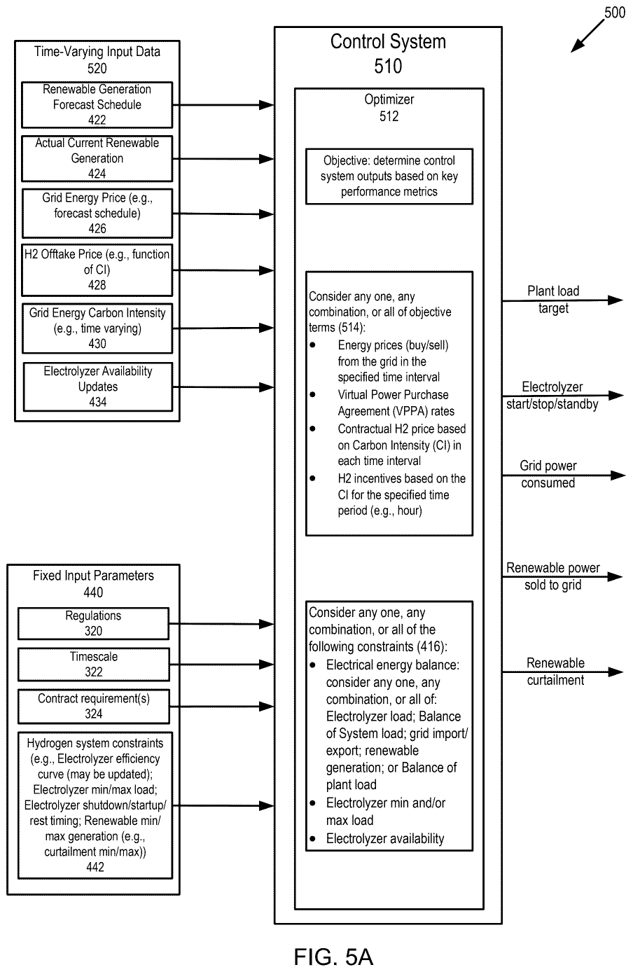

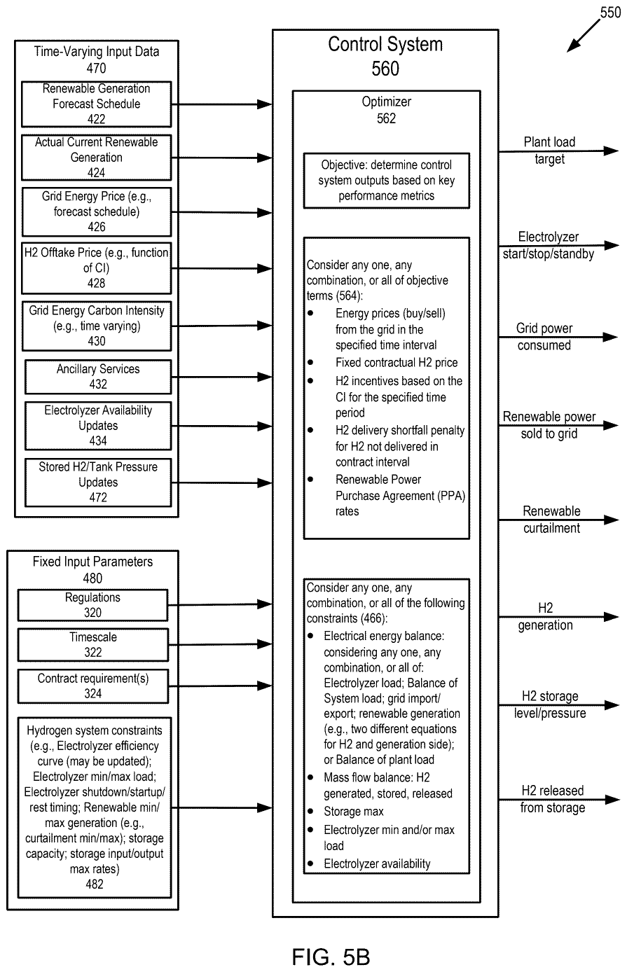

FIG. 5A is a first block diagram 500 of the control system for a VPPA green hydrogen plant with no offtake constraint, illustrating inputs to (e.g., time varying input data 520; fixed input parameters 440) and outputs from the control system, and with the control system 510 including an optimizer 512, objective terms 514, and constraints 416. As shown, the objective terms 514 may include any one, any combination, or all of: energy prices (buy/sell) from the grid in the specified time interval; Virtual Power Purchase Agreement (VPPA) rates; contractual H₂ price based on CI in each time interval (e.g., each hour); H₂ incentives based on the CI for the specified time period (e.g., hour).

FIG. 5B is a second block diagram 550 of the control system 560 for a VPPA green hydrogen plant with an offtake constraint, illustrating inputs to (e.g., time varying input data 470; fixed input parameters 480) and outputs from the control system, and with the control system 560 including an optimizer 562, objective terms 564, and constraints 466. As shown, the objective terms 564 may include any one, any combination, or all of: energy prices (buy/sell) from the grid in the specified time interval; fixed contractual H₂ price; H₂ incentives based on the CI for the specified time period; H₂ delivery shortfall penalty for H₂ not delivered in contract interval; renewable Power Purchase Agreement (PPA) rates

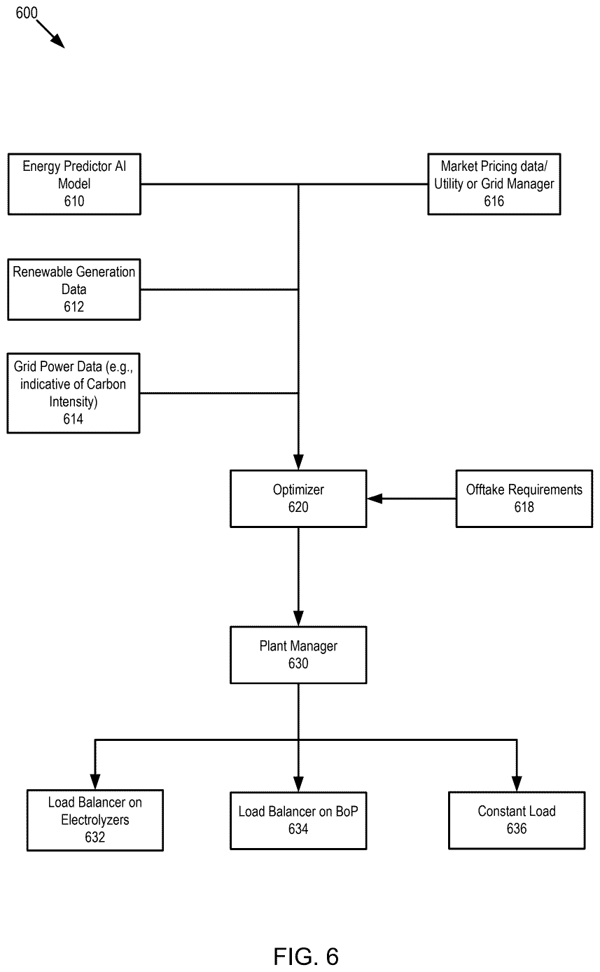

FIG. 6 is a fourth block diagram 600 of the hydrogen system, the power sources and the control system, which is, by example, illustrated as optimizer 620. In particular, FIG. 6 illustrates as inputs to the optimizer 620 as including any one, any combination, or all of: energy predictor AI model 610; renewable generation data 612; grid power data 614; market pricing data/utility or grid manager 616; or offtake requirements 618. As discussed above, the renewable energy available may be forecasted by an AI model, such as energy predictor AI model 610. Further, actual renewable energy data, such as real-time renewable energy data, may comprise renewable generation data 612. Various aspects of the power grid may be received via grid power data 614 (e.g., pollutant metric) and/or market pricing data/utility or grid manager 616. Further, offtake requirements 618 may be indicative of contract requirements for producing minimums and/or maximums of hydrogen and/or hydrogen-derived products.

Based on the inputs, the optimizer 620 is configured to generate one or more commands to send to the plant manager 630, which may comprise a controller for the hydrogen plant. In turn, the plant manager 630 may implement the one or more commands received from the optimizer 620, such as controlling any one, any combination, or all of: load balancer of electrolyzers 632; load balancer of BoP 634; or constant load 636. Thus, the plant manager 630 may receiving the commands from the optimizer 620, with the commands being in the form of target load(s) for control of operation of any one, any combination, or all of the electrolyzer(s), the hydrogen compression/storage, or the hydrogen derivative generation. In this way, the plant manager 630 may, knowing the hydrogen system constraints (e.g., minimum turndown, etc.) equipment constraints, may implement that target load(s) (e.g., the plant manager 630 distributes amongst all of the electrolyzers in the hydrogen facility in order to meet the target load as dictated by the optimizer 620 and also to meet the constraints of the system, such as operating each of the electrolyzers at its minimum designated operation of 15 MW). Thus, in one or some embodiments, a two-tier level of control may be formed with the optimizer 620 and the plant manager 630, with the optimizer 620 configured to account for the constraints of the hydrogen system while optimizing operation in generating the target load(s), and with the plant manager 630 (with the lower-level knowledge of the operation of the hydrogen system) to implement the target load(s)).

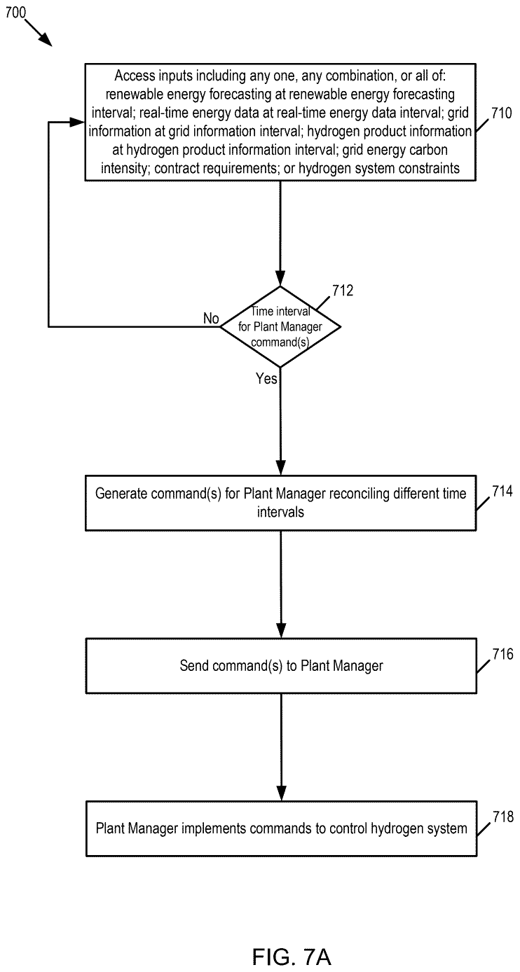

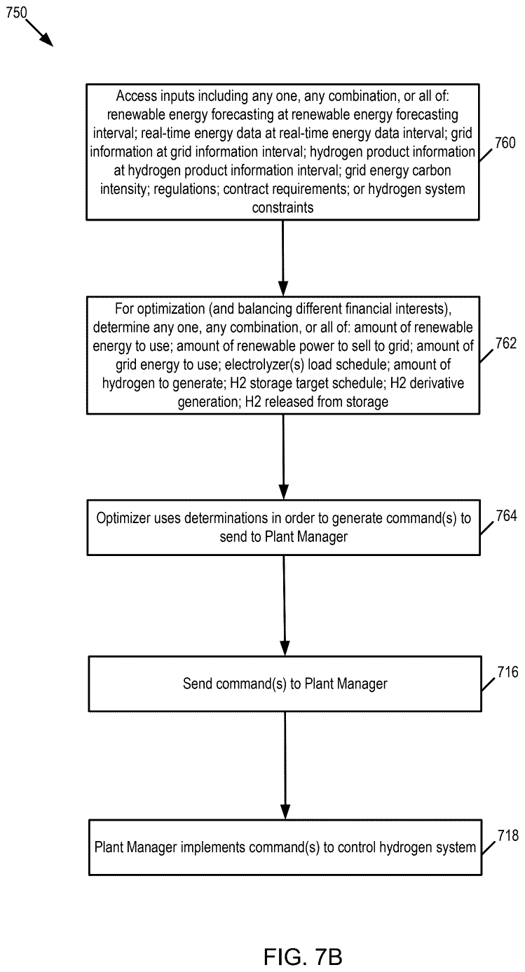

FIG. 7A is a flow chart 700 for controlling the hydrogen system by reconciling different time intervals. At 710, one or more inputs are accessed including any one, any combination, or all of: renewable energy forecasting at renewable energy forecasting interval; real-time energy data at real-time energy data interval; grid information at grid information interval; hydrogen product information at hydrogen product information interval; grid energy carbon intensity; contract requirements; or hydrogen system constraints. At 712, it is determined whether it is the time (e.g., the time interval) to issue command(s) to the plant manager. If not, flow chart 700 loops back to 710. If so, at 714, the command(s) are generated to send to the Plant Manager, with the generation of the commands reconciling the different time intervals. At 716, the commands are sent to the Plant Manager. At 718, the Plant Manager implements the commands in order to control one or more parts of the hydrogen system.

FIG. 7B is a flow chart 750 for controlling the hydrogen system by balancing different financial interests. At 760, one or more inputs are accessed including any one, any combination, or all of: renewable energy forecasting at renewable energy forecasting interval; real-time energy data at real-time energy data interval; grid information at grid information interval; hydrogen product information at hydrogen product information interval; grid energy carbon intensity; regulations; contract requirements; or hydrogen system constraints. At 762, for optimization (and balancing different financial interests), any one, any combination, or all of the following may be determined: amount of renewable energy to use; amount of renewable power to sell to grid; amount of grid energy to use; electrolyzer(s) load schedule; amount of hydrogen to generate; H₂ storage target schedule; H₂ derivative generation; H₂ released from storage. At 764, the optimizer may use the determinations in 762 in order to generate command(s) to send to Plant Manager. After which, at 716, the commands are sent to the Plant Manager, and at 718, the Plant Manager implements the commands in order to control one or more parts of the hydrogen system.

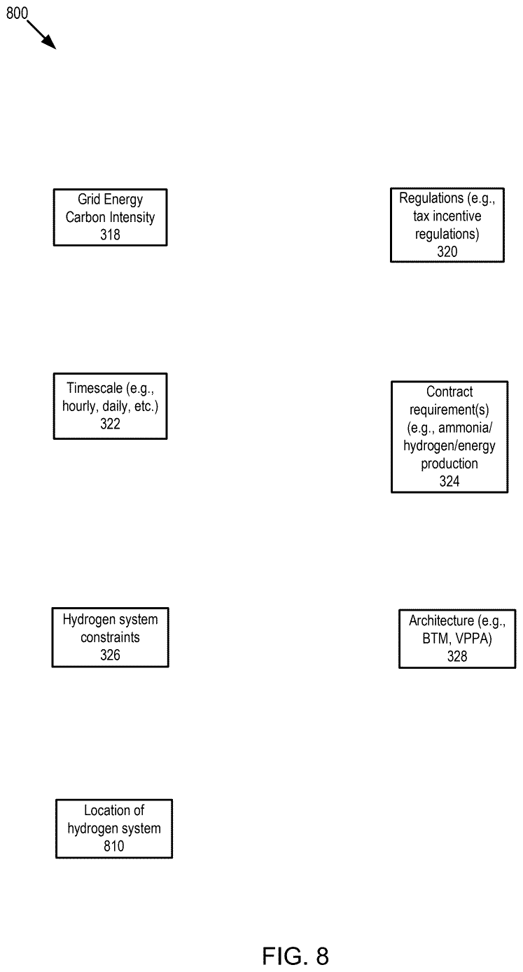

As discussed above, the control system may be tailored based on input from a user, such as input via one or more user interface (e.g., graphical user interfaces). FIG. 8 is an example user interface 800 with one or more fields for configuring the control system. In particular, FIG. 8 illustrates the following inputs: grid energy carbon intensity (CI) 318; regulations 320; timescale 322; contract requirement(s) 324; hydrogen system constraints 326; architecture 328; or location of hydrogen system 810. Fewer or greater numbers of fields are contemplated. Thus, via the user interface(s), the control system may be tailored to the specific hydrogen system, which may enable customizable modeling.

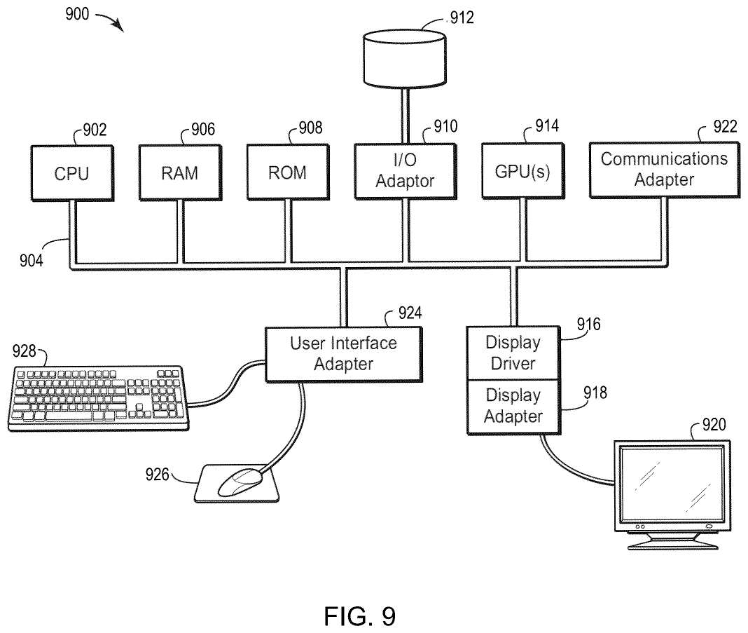

As discussed above, various electronic devices may be used in the system, such as the control system (e.g., the optimizer) or the plant manager, as embodied in the block diagrams in FIGS. 1, 2A-B, 3A-B, 4A-B, 5A-B, or 6, the flow charts in FIGS. 7A-B, or the user interface in FIG. 8. The electronic devices may include computing functionality, an example of which is illustrated in FIG. 9, which is a diagram of an exemplary computer system 900 that may be utilized to implement the systems and methods, including the flow diagrams, described herein. A central processing unit (CPU) 902 is coupled to system bus 904. The CPU 902 may be any general-purpose CPU, although other types of architectures of CPU 902 (or other components of exemplary computer system 900) may be used as long as CPU 902 (and other components of computer system 900) supports the operations as described herein. Those of ordinary skill in the art will appreciate that, while only a single CPU 902 is shown in FIG. 9, additional CPUs may be present. Moreover, the computer system 900 may comprise a networked, multi-processor computer system that may include a hybrid parallel CPU/GPU system. The CPU 902 may execute the various logical instructions according to various teachings disclosed herein. For example, the CPU 902 may execute machine-level instructions for performing processing according to the operational flow described herein.

The computer system may also include computer components such as non-transitory, computer-readable media. Examples of computer-readable media include computer-readable non-transitory storage media, such as a random-access memory (RAM) 906, which may be SRAM, DRAM, SDRAM, or the like. The computer system may also include additional non-transitory, computer-readable storage media such as a read-only memory (ROM) 908, which may be PROM, EPROM, EEPROM, or the like. RAM 906 and ROM 908 hold user and system data and programs, as is known in the art. In this regard, computer-readable media may comprise executable instructions to perform any one, any combination, or all of the blocks in the flow charts in FIGS. 10-12. The computer system may also include an input/output (I/O) adapter 910, a graphics processing unit (GPU) 914, a communications adapter 922 (e.g., a communication interface), a user interface adapter 924, a display driver 916, and a display adapter 918.

The I/O adapter 910 may connect additional non-transitory, computer-readable media such as storage device(s) 912, including, for example, a hard drive, a compact disc (CD) drive, a floppy disk drive, a tape drive, and the like to computer system. The storage device(s) may be used when RAM 906 is insufficient for the memory requirements associated with storing data for operations of the present techniques. The data storage of the computer system may be used for storing information and/or other data used or generated as disclosed herein. For example, storage device(s) 912 may be used to store configuration information or additional plug-ins in accordance with the present techniques. Further, the user interface adapter 924 couples user input devices, such as a keyboard 928, a pointing device 926 and/or output devices to the computer system. The display adapter 918 is driven by the CPU 902 to control the display on a display device 920 to, for example, present information to the user such as images generated according to methods described herein.

The architecture of the computer system may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system may include various plug-ins and library files. Input data may additionally include configuration information.

It is intended that the foregoing detailed description be understood as an illustration of selected forms that the invention may take and not as a definition of the invention. It is only the following claims, including all equivalents, which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

What is claimed is:

1. A method for automatically controlling a hydrogen system powered at least partly by renewable energy, the method comprising:
automatically accessing an estimated amount of renewable energy for powering the hydrogen system;
automatically accessing a renewable indicator of grid power from a grid for powering the hydrogen system, the renewable indicator indicative of an amount or percentage of the grid power being generated by one or more renewable energy resources; and
automatically controlling, based on analyzing both the estimated amount of the renewable energy and the renewable indicator of the grid power in combination, operation of the hydrogen system.

2. The method of claim 1, wherein the operation of the hydrogen system is to at least meet a greenness metric of being operated using the renewable energy;
wherein analyzing both the estimated amount of the renewable energy and the renewable indicator of the grid power in combination comprises determining, for a respective time interval of the operation of the hydrogen system, using a first amount of power from the renewable energy and a second amount of power from the grid to at least meet the greenness metric of the hydrogen system being operated using the renewable energy; and
wherein automatically controlling comprises commanding the first amount of power be routed from the renewable energy to the hydrogen system and the second amount of power from the grid to the hydrogen system in order to operate the hydrogen system in the respective time interval.

3. The method of claim 2, further comprising automatically accessing one or more contractual conditions for the hydrogen system to generate hydrogen or hydrogen-derived products; and
wherein determining, for the respective time interval of the operation of the hydrogen system, using the first amount of power from the renewable energy and the second amount of power from the grid to at least meet the greenness metric of the hydrogen system in generating the hydrogen or the hydrogen-derived products to meet the one or more contractual conditions.

4. The method of claim 3, further comprising automatically accessing one or more operational constraints for one or both of the hydrogen system in its operation or the grid in providing the grid power; and
wherein determining, for the respective time interval of the operation of the hydrogen system, using the first amount of power from the renewable energy and the second amount of power from the grid to at least meet the greenness metric of the hydrogen system in generating the hydrogen or the hydrogen-derived products to meet the one or more contractual conditions and to comply with the one or more operational constraints for one or both of the hydrogen system in its operation or the grid in providing the grid power.

5. The method of claim 1, wherein the estimated amount of renewable energy is for a renewable energy interval;
wherein the grid power from the grid is for a power grid interval;
wherein the hydrogen system operates according to a renewable metric interval;
wherein the renewable metric interval is different from one or both of the renewable energy interval or the power grid interval; and
wherein automatically controlling, based on analyzing both the estimated amount of the renewable energy and the renewable indicator of the grid power in combination, operation of the hydrogen system comprises:
automatically generating, by reconciling the renewable metric interval with the one or both of the renewable energy interval and the power grid interval, one or more commands for control of the hydrogen system; and
automatically controlling, using the one or more commands, the hydrogen system.

6. The method of claim 5, wherein the renewable metric is indicative of non-renewable energy or emission intensity used for producing one or both of hydrogen or hydrogen-derived products;
wherein the renewable energy interval is less than the renewable metric interval comprising a plurality of sub-intervals of the renewable metric interval;
wherein for each respective sub-interval of the plurality of sub-intervals:
the estimated amount of renewable energy is automatically generated;
a load amount for powering at least a part of the hydrogen system is automatically generated, wherein the load amount is automatically generated based on the estimated amount of renewable energy; and
the load amount is used to generate the one or more commands in order to automatically control the hydrogen system to power the at least part of the hydrogen system for the respective sub-interval; and
wherein the load amount for each of the plurality of sub-intervals is automatically selected so that a sum of the non-renewable energy or the emission intensity, used for the plurality of sub-intervals to produce the one or both of the hydrogen or the hydrogen-derived products, results in a value for the renewable metric to be less than a predetermined amount.

7. The method of claim 6, wherein the renewable energy is generated from one or more renewable energy systems; and
wherein, for each respective sub-interval, the estimated amount of renewable energy is determined by:
accessing, for the respective sub-interval, a forecasted amount of the renewable energy generated by the one or more renewable energy systems; and
modifying the load amount for the respective sub-interval with real-time generation data indicative of a real-time amount of the renewable energy generated by the one or more renewable energy systems.

8. The method of claim 7, wherein the forecasted amount of renewable energy generated by the one or more renewable energy systems is generated by at least one of a machine-learned model or a third-party forecasting service.

9. The method of claim 8, wherein power from the power grid has an associated amount of carbon emitted per amount of the power from the power grid;
wherein the renewable metric comprises carbon intensity, wherein the carbon intensity comprises a ratio of the amount of carbon emitted from the power used by the hydrogen system in the renewable energy interval to the amount of the one or both of the hydrogen or the hydrogen-derived products produced by the hydrogen system in the renewable energy interval; and
wherein, for each respective sub-interval of the plurality of sub-intervals, the load amount is automatically generated so that a total value of the amount of carbon emitted from the power routed from the power grid and used by the hydrogen system in the renewable energy interval and a total amount of the one or both of the hydrogen or the hydrogen-derived products produced by the hydrogen system in the renewable energy interval results in an actual ratio that is less than a predetermined amount.

10. The method of claim 9, wherein the load amount for powering the hydrogen system is automatically generated based on knowledge of efficiency of the hydrogen system so that the total value of the amount of carbon emitted from the power from the power grid used by the hydrogen system in the renewable energy interval and the total amount of the one or both of the hydrogen or the hydrogen-derived products produced by the hydrogen system in the renewable energy interval results in the actual ratio that is less than the predetermined amount.

11. The method of claim 10, wherein the at least one aspect of grid power energy comprises pricing for a respective power grid interval of power from the power grid; and
wherein the load amount for powering the hydrogen system is automatically generated by optimizing costs for the one or both of the hydrogen or the hydrogen-derived products produced by the hydrogen system and for the actual ratio to be less than the predetermined amount.

12. The method of claim 11, wherein, in optimizing the costs, the load amount is reduced so that less of the one or both of the hydrogen or the hydrogen-derived products is produced.

13. The method of claim 11, wherein the actual ratio for the carbon intensity being less than or equal to the predetermined amount has greater financial benefits;
wherein the actual ratio for the carbon intensity being greater than the predetermined amount has less financial benefit;
wherein the hydrogen system is subject to a contract for requirements for production of the one or both of the hydrogen or the hydrogen-derived products with financial penalties for failing to meet the requirements for the production of the one or both of the hydrogen or the hydrogen-derived products;
wherein the one or more commands control the production of the one or both of the hydrogen or the hydrogen-derived products; and
wherein generating the one or more commands is based on:
the greater financial benefits or lesser financial benefits of carbon intensity by generating an estimated ratio of an estimated amount of carbon emitted from the power used by the hydrogen system in the renewable energy interval to an estimated amount of the one or both of the hydrogen or the hydrogen-derived products produced by the hydrogen system in the renewable energy interval; and
the production of the one or both of the hydrogen or the hydrogen-derived products for the hydrogen system including the financial penalties for failing to meet the requirements for the production of the one or both of the hydrogen or the hydrogen-derived products.

14. The method of claim 13, wherein the hydrogen system includes one or more electrolyzers configured to generate the hydrogen and downstream equipment configured to store the hydrogen or to generate the hydrogen-derived products;
wherein the one or more electrolyzers have an associated timescale constraint for operation;
wherein the downstream equipment has an associated timescale constraint for operation;
wherein the timescale constraint for the one or more electrolyzers is different from the timescale constraint of the downstream equipment; and
wherein the one or more commands are generated by factoring the timescale constraint for the one or more electrolyzers and the timescale constraint of the downstream equipment so that the one or more electrolyzers are controlled differently than the downstream equipment, thereby accounting for a difference in the timescale constraint for the one or more electrolyzers from the timescale constraint of the downstream equipment.

15. The method of claim 14, wherein balance of system load is indicative of power for operating the one or more electrolyzers;
wherein balance of plant load is indicative of power for operating the downstream equipment; and
wherein generating the one or more commands further accounts for the requirements for production of the hydrogen and the hydrogen-derived products and the financial penalties for failing to meet the requirements for the production of the hydrogen and the hydrogen-derived products.

16. A hydrogen system powered at least partly by renewable energy, the hydrogen system comprising:
one or more electrolyzers; and
a control system in communication with the one or more electrolyzers and configured to:
automatically access an estimated amount of renewable energy for powering the hydrogen system;
automatically access a renewable indicator of grid power from a grid for powering the hydrogen system, the renewable indicator indicative of an amount or percentage of the grid power being generated by one or more renewable energy resources; and
automatically control, based on analyzing both the estimated amount of the renewable energy and the renewable indicator of the grid power in combination, the one or more electrolyzers of the hydrogen system.

17. The hydrogen system of claim 16, wherein operation of the hydrogen system is to at least meet a greenness metric of being operated using the renewable energy;
wherein the control system is configured to analyze both the estimated amount of the renewable energy and the renewable indicator of the grid power in combination comprises determining, for a respective time interval of the operation of the hydrogen system, using a first amount of power from the renewable energy and a second amount of power from the grid to at least meet the greenness metric of the hydrogen system being operated using the renewable energy; and
wherein the control system is configured to automatically control by commanding routing the first amount of power from the renewable energy to the hydrogen system and the second amount of power from the grid to the hydrogen system in order to operate the hydrogen system in the respective time interval.

18. The hydrogen system of claim 17, wherein the control system is further configured to automatically access one or more contractual conditions for the hydrogen system to generate hydrogen or hydrogen-derived products; and
wherein the control system is configured to determine, for the respective time interval of the operation of the hydrogen system, using the first amount of power from the renewable energy and the second amount of power from the grid to at least meet the greenness metric of the hydrogen system in generating the hydrogen or the hydrogen-derived products to meet the one or more contractual conditions.

19. The hydrogen system of claim 18, wherein the control system is further configured to automatically access one or more operational constraints for one or both of the hydrogen system in its operation or the grid in providing the grid power; and
wherein the control system is configured to determine, for the respective time interval of the operation of the hydrogen system, using the first amount of power from the renewable energy and the second amount of power from the grid to at least meet the greenness metric of the hydrogen system in generating the hydrogen or the hydrogen-derived products to meet the one or more contractual conditions and to comply with the one or more operational constraints for one or both of the hydrogen system in its operation or the grid in providing the grid power.

20. The hydrogen system of claim 16, wherein the estimated amount of renewable energy is for a renewable energy interval;
wherein the grid power from the grid is for a power grid interval;
wherein the hydrogen system is configured to operate according to a renewable metric interval;
wherein the renewable metric interval is different from one or both of the renewable energy interval or the power grid interval; and
wherein the control system is configured to automatically control, based on analyzing both the estimated amount of the renewable energy and the renewable indicator of the grid power in combination, operation of the hydrogen system by:
automatically generating, by reconciling the renewable metric interval with the one or both of the renewable energy interval and the power grid interval, one or more commands for control of the one or more electrolyzers; and
automatically controlling, using the one or more commands, the one or more electrolyzers.
